(19) United States
(12) Patent Application Publication
(10) Pub. No.: US 2026/0001239 A1
(43) Pub. Date: Jan. 1, 2026

(54) CLAMPING OR GRIPPING DEVICE WITH MULTIFUNCTIONAL SHAFT

(71) Applicant: SCHUNK SE & Co. KG Spanntechnik Greiftechnik Automatisierungstechnik, Lauffen am Neckar (DE)

(72) Inventors: Jochen Alf, Ludwigsburg (DE); Kevin Schäffler, Ilsfeld (DE); Philipp Holaschke, Eppingen (DE); Daniel Kiesow, Leingarten (DE)

(21) Appl. No.: 19/109,480

(22) PCT Filed: Aug. 9, 2023
(86) PCT No.: PCT/EP2023/071992

§ 371 Date: Mar. 6, 2025

(30) Foreign Application Priority Data
Sep. 9, 2022 (DE) 102022123042.2

(51) Int. Cl. B25J 15/02; B25J 9/10; B25J 19/02

(52) U.S. Cl. CPC B25J 15/026; B25J 9/102; B25J 19/02

(57) ABSTRACT

A clamping device includes a housing having a jaw guide arranged in the housing and extending along an axis and a gripping jaw which is movable in the jaw guide between a gripping position and a release position. A drive device for moving the gripping jaw includes a rotary drive and a drive shaft. The drive shaft extends perpendicular to the axis and rotatably mounted in the housing for connecting the rotary drive and the gripping jaw. A transmission device includes a position measuring device for detecting an angle of rotation of the drive device and/or for detecting the position of the gripping jaw. The housing includes a partition wall which divides the interior of the housing into a transmission portion for the transmission device and an electronic portion for the rotary drive and/or the position measuring device.

The invention relates to a clamping or gripping device, in particular a parallel gripper, for clamping or gripping workpieces.

EP 1 905 549 A1 discloses a gripping device with a rotary drive and two slides synchronized by means of a synchronous gearwheel, wherein a toothing is provided on each slide for engagement with the synchronous gearwheel.

The object underlying the invention is to provide a reliable and easy-to-manufacture clamping or gripping device.

The object is achieved by means of an object having the features of claim 1. The clamping or gripping device has a main housing, at least one jaw guide arranged in the main housing and extending along a guide axis. At least one gripping jaw, in particular two, three or more gripping jaws, is arranged and displaceably mounted in the jaw guide, wherein the gripping jaw is movable along the guide axis between a gripping position and a release position. The gripping jaw can also be designed as a clamping element. The clamping or gripping device further comprises a drive device for moving the at least one gripping jaw, wherein the drive device comprises a rotary drive and a drive shaft extending perpendicular to the guide axis and along a drive axis and rotatably mounted in the main housing for connecting the rotary drive. The rotary drive can be designed as an electric motor, in particular as an external rotor motor. Furthermore, the drive device has a transmission device and/or a clutch device. The clamping or gripping device has a position measuring device for detecting the angle of rotation of the drive device, in particular of the rotary drive and/or the drive shaft, and/or for detecting the position of the at least one gripping jaw, wherein the position of the gripping jaw can be determined, among other things, by means of the angle of the drive shaft.

The main housing of the clamping or gripping device is divided by a partition into a transmission and/or clutch portion and an electronic portion. The transmission device and/or the clutch device are arranged in the transmission and/or clutch portion, and the rotary drive and the position measuring device are arranged in the electronic portion. Due to the spatial separation of the transmission and/or clutch portion and the electronic portion, the sensitive components arranged in the electronic portion, e.g. electric motor, position measuring device or control system, etc., can be protected from the harsh conditions in the region of the transmission and clutch devices. This prevents dirt, abrasion, liquids and greases from the transmission and/or clutch portion from getting to the electronic portion. This leads to a reliable and long-lasting use of the clamping or gripping device.

The main housing can be designed in one piece. The main housing can further comprise at least two housing parts with at least one outer housing and the partition. The at least one outer housing and/or the partition can be screwed together. Furthermore, the outer housing can have flat seals against the environment and the partition for sealing or separating the transmission and/or clutch portion and the electronic portion. The partition can also be designed in such a way that the clamping or gripping device is particularly stable and rigid. The partition can further comprise at least one step, wherein a larger installation space for the transmission and/or clutch device is provided on the transmission and/or clutch side in the region of the drive device, and a larger installation space, in particular a circuit board space for printed circuit boards, etc., is provided on the electronics side in the region of a regulation and/or control device.

Furthermore, the drive shaft is provided in the main housing in such a way that the drive shaft extends into the electronic portion. Accordingly, information on e.g. position, speed, vibration, temperature etc. of the drive device, in particular the drive shaft or the gripper jaw, can be recorded directly in the electronics region. It is not necessary for the position measuring device or a part thereof to be arranged in the transmission and/or clutch portion or on the gripping jaw. This can ensure a particularly long-lasting position measuring device.

It is advantageous if the transmission and/or clutch portion is arranged between the at least one gripping jaw and the electronic portion. Accordingly, a particularly efficient drive device is formed, wherein a sufficient distance is created between the electronic components and the traversing range of the jaws or the production environment.

An advantageous development of the invention provides that the drive shaft extends through the transmission and/or clutch portion. This makes it possible for the drive shaft to be designed multifunctional and fulfill a variety of functions. The drive shaft can serve to transmit the kinetic energy to the at least one gripping jaw, to support transmission and/or clutch portions, and to provide a connection point for a position measuring device.

Advantageously, the drive shaft is rotatably mounted in the partition of the main housing. This ensures particularly safe mounting of the drive shaft.

It is advantageous if the drive shaft has a first free end, wherein the first free end of the drive shaft is arranged in the electronic portion. Accordingly, the main housing, in particular the outer housing, can be designed to be closed in the electronic portion.

An advantageous further development provides that the position measuring device has an angle measuring device cooperating with the drive shaft, in particular with the first free end. The angle measuring device is preferably connected to the drive shaft for conjoint rotation and/or rigidly. The position of the gripping jaw can easily be determined with reference to the angle of the drive shaft. In particular, the angle measuring device can be designed as an absolute encoder.

Advantageously, the angle measuring device is arranged radially offset from the drive axis. The angle measuring device can advantageously be connected to the drive shaft by means of a belt element, in particular a belt. It is also advantageous if the belt reduces the rotational speed of the drive shaft toward the angle measuring device. This allows the entire travel path of the gripper jaw to be recorded with a simple and inexpensive single-turn encoder. It is particularly advantageous if the rotational speed of the drive shaft is reduced in such a way that the stroke of the at least one gripping jaw corresponds to a complete rotation, i.e. 360°, of the angle measuring device. For coupling with the belt, a toothing can be provided at the first free end. The toothing can be pushed or screwed onto the first free end by means of a sleeve-shaped or cylindrical pinion or can be an integral component of the drive shaft.

It is advantageous if the rotary drive comprises a motor regulation device, in particular an incremental encoder, for motor regulation and commutation. The motor regulation device preferably comprises a timing disk and/or a light barrier. It is advantageous that the timing disk is rigidly connected to the rotary drive, in particular to the motor shaft. The light barrier detects the rotation of the timing disk and accordingly records the rotation of the rotary drive.

Furthermore, it is advantageous if the drive shaft has a second free end opposite the first free end. A drive pinion can be arranged at the second free end of the drive shaft. A toothing, in particular a rack profile cooperating with the drive pinion, can be provided on the at least one gripping jaw. During operation, the drive pinion meshes with the rack profile. The drive pinion can be sleeve-shaped and pushed onto the second free end or be an integral component of the drive shaft.

An advantageous further development provides that the clutch device is designed as a claw clutch and has a first clutch element, a second clutch element and at least one elastomer element arranged in the circumferential direction between the first clutch element and the second clutch element. Such a clutch device ensures good power transmission, wherein the elastomer element serves to secure the gripping force of the at least one gripping jaw. The first clutch element can preferably have at least one or at least two, in particular two or four, claws extending parallel to the drive axis. The second clutch element has a clutch receptacle for receiving the first clutch element and the elastomer element.

It is advantageous if the first clutch element faces the drive pinion and is connected to the drive shaft for conjoint rotation, and if the second clutch element faces away from the drive pinion and is rotatably mounted on the drive shaft. Accordingly, the drive shaft can be used to support the second clutch element. The first clutch element can in particular be pushed onto the drive shaft or formed as a single piece therewith.

Furthermore, it is advantageous if the transmission device has a first double pinion arranged on the drive shaft. The first double pinion can be mounted radially on the drive shaft and axially on the partition. In the main housing, in particular in the transmission and/or clutch portion, a bearing shaft extending parallel and at a distance from the drive shaft can be provided, wherein a second double pinion cooperating with the first double pinion is arranged on the bearing shaft for power transmission.

Advantageously, the second clutch element has a clutch pinion that interacts with the second double pinion. The clutch pinion is arranged radially on the outside of the receptacle of the second clutch element.

An advantageous further development of the invention provides that the rotary drive is designed as an external rotor motor and/or has an output pinion cooperating with the first double pinion. This allows the power to be transferred from the rotary drive to the drive shaft.

It is advantageous if a braking device is provided on the drive device for maintaining the gripping force, wherein the braking device can be designed as a magnetic brake with a braking pinion cooperating with the first double pinion. The braking device, in particular the magnetic brake, can preferably be arranged in the electronic portion. The brake pinion can preferably be arranged in the transmission and/or clutch portion. Should the drive device, in particular the rotary drive, fail, the gripping force on the at least one gripping jaw is maintained by the braking device.

An advantageous further development provides that the clamping or gripping device has a control and regulation device for controlling and/or regulating the drive device, the braking device, the position measuring device and/or the motor regulation device. The control and regulation device preferably has a motherboard and/or a communication circuit board. The communication circuit board can include IO-Link, Ethernet and/or Modbus, among others. When using Ethernet, the control and regulation device has an Ethernet communication circuit board in addition to the communication circuit board.

The motherboard preferably serves to control the rotary drive and/or the braking device, and/or to evaluate the position measuring device and/or the motor regulation device. Furthermore, the motherboard can be used for data processing and/or setting the parameters of the clamping or gripping device. The motherboard can also process the communication of the mentioned communication types of the communication circuit boards. In addition, the motherboard preferably has a galvanic isolation between the logic processing and the motor control.

The clamping or gripping device preferably has a brake chopper which is arranged in particular in the circuit board space. The brake chopper is used to reduce the feedback voltage of the rotary drive in order to thereby protect the employed power supplies. The brake chopper preferably measures the motor voltage and is controlled by means of the control and/or regulation device, in particular by means of the motherboard.

Further details and advantageous embodiments of the invention can be found in the following description, on the basis of which one embodiment of the invention will be described and explained in more detail,

In the drawings:

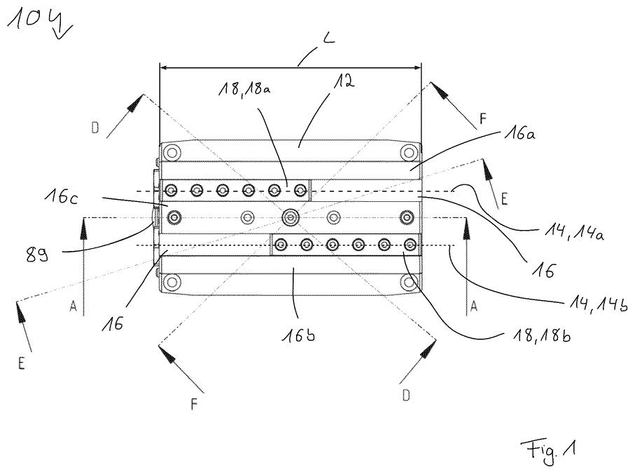

FIG. 1 shows a schematic top view of a clamping or gripping device according to the invention;

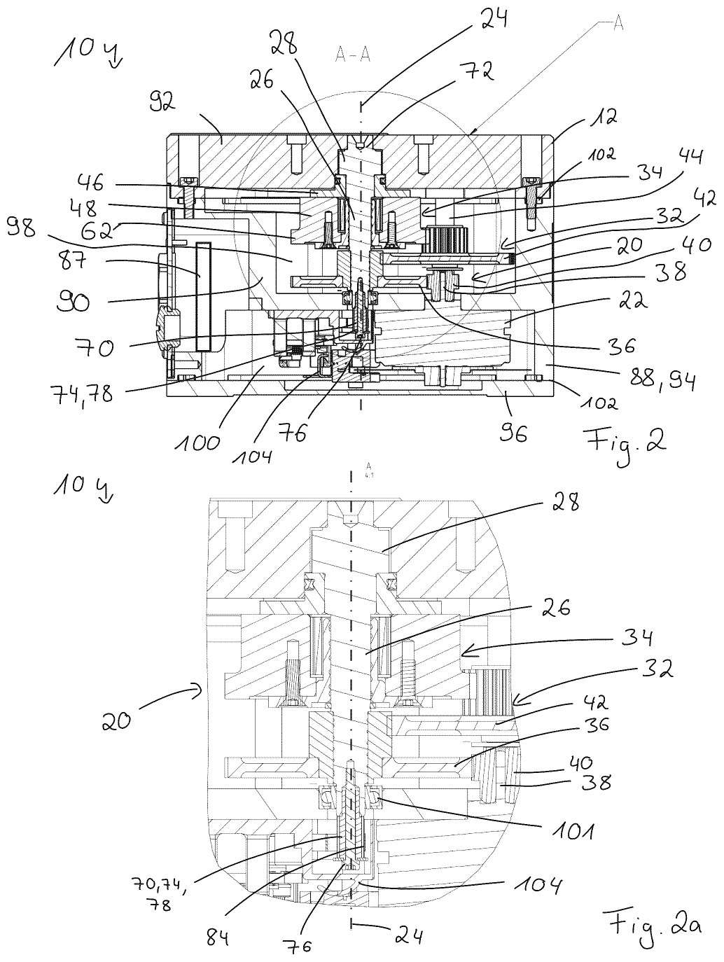

FIG. 2 shows a schematic sectional view along section A-A of the clamping or gripping device according to FIG. 1;

FIG. 2a shows a schematic detail view of detail A of FIG. 2;

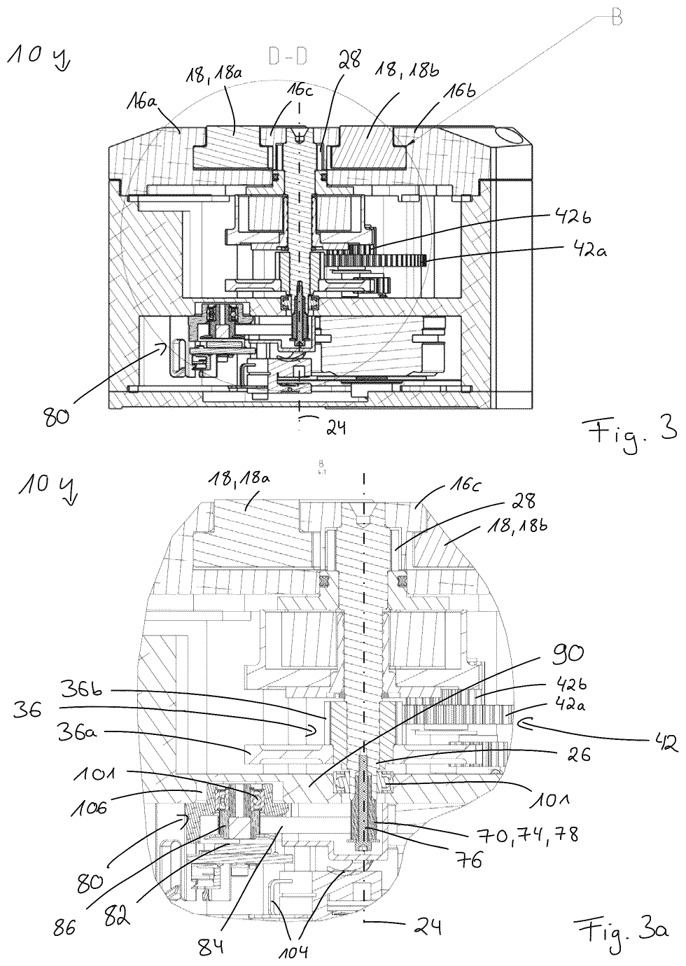

FIG. 3 shows a schematic sectional view along section D-D of the clamping or gripping device according to FIG. 1;

FIG. 3a shows a schematic detail view of detail B of FIG. 3;

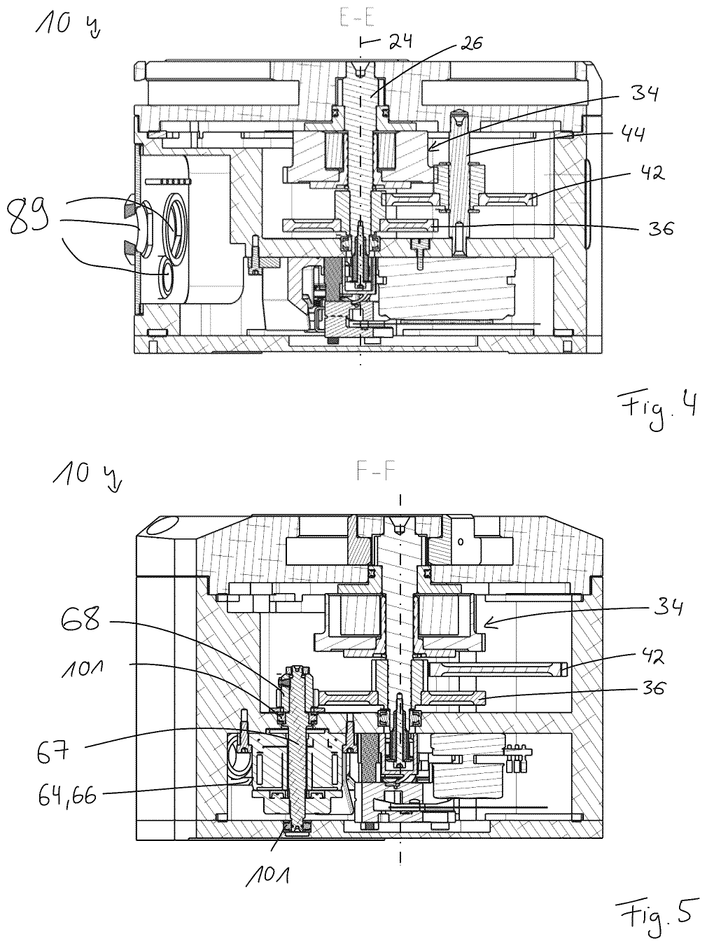

FIG. 4 shows a schematic sectional view along section E-E of the clamping or gripping device according to FIG. 1;

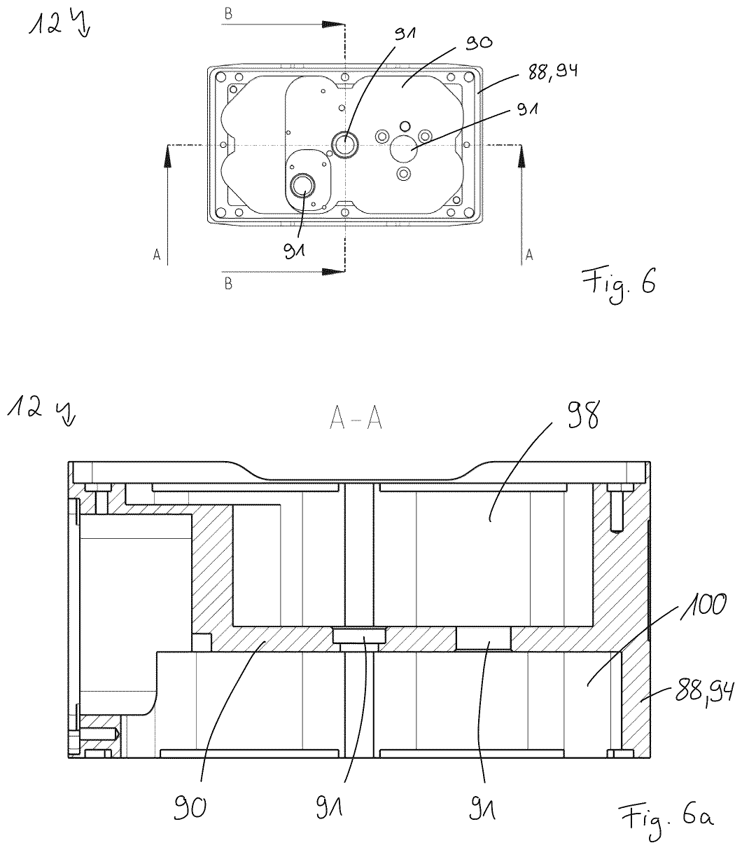

FIG. 5 shows a schematic sectional view along section F-F of the clamping or gripping device according to FIG. 1;

FIG. 6 shows a schematic bottom view in the main housing of the clamping or gripping device according to FIG. 1;

FIG. 6a shows a schematic sectional view along section A-A of the main housing according to FIG. 6;

FIG. 7a shows a schematic side view of a drive shaft according to the invention;

FIG. 7b shows a schematic side view of the drive shaft according to FIG. 7a with a first clutch element;

FIG. 7c shows a schematic side view of the drive shaft according to FIG. 7a with a clutch device;

FIG. 7d shows a schematic sectional view of the drive shaft according to FIG. 7c;

FIG. 8a shows a schematic bottom view of the drive shaft according to FIG. 7a with position measuring device;

FIG. 8b shows a schematic side view of the drive shaft according to FIG. 8a;

FIG. 8c shows a schematic top view of the drive shaft according to FIG. 8a;

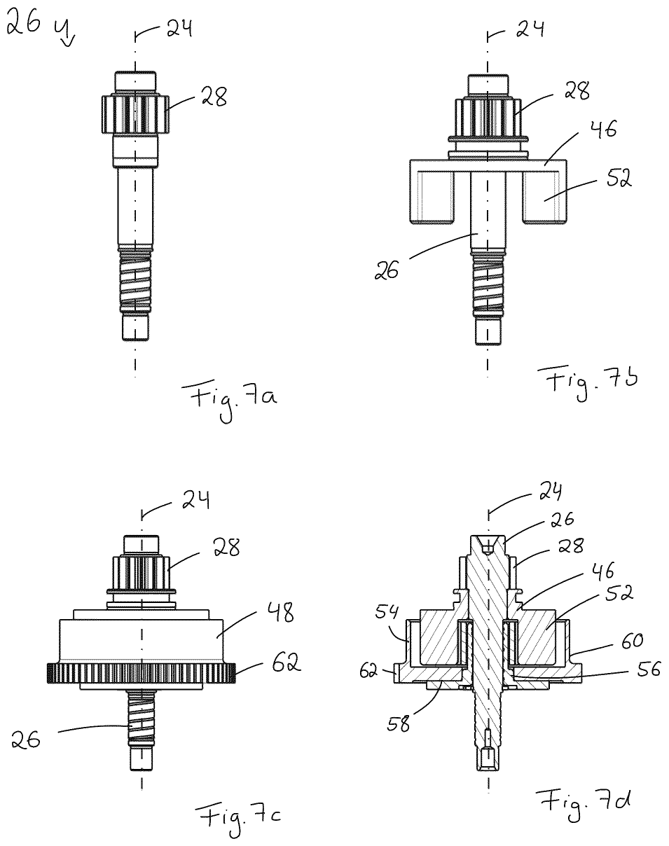

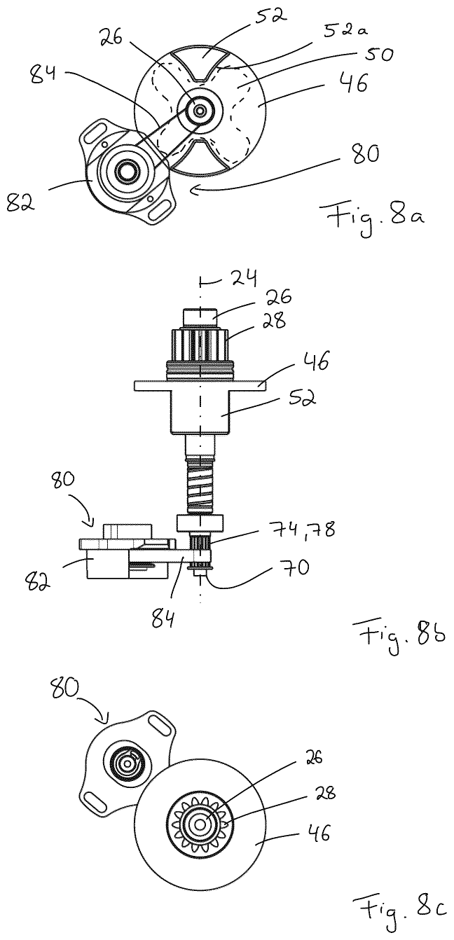

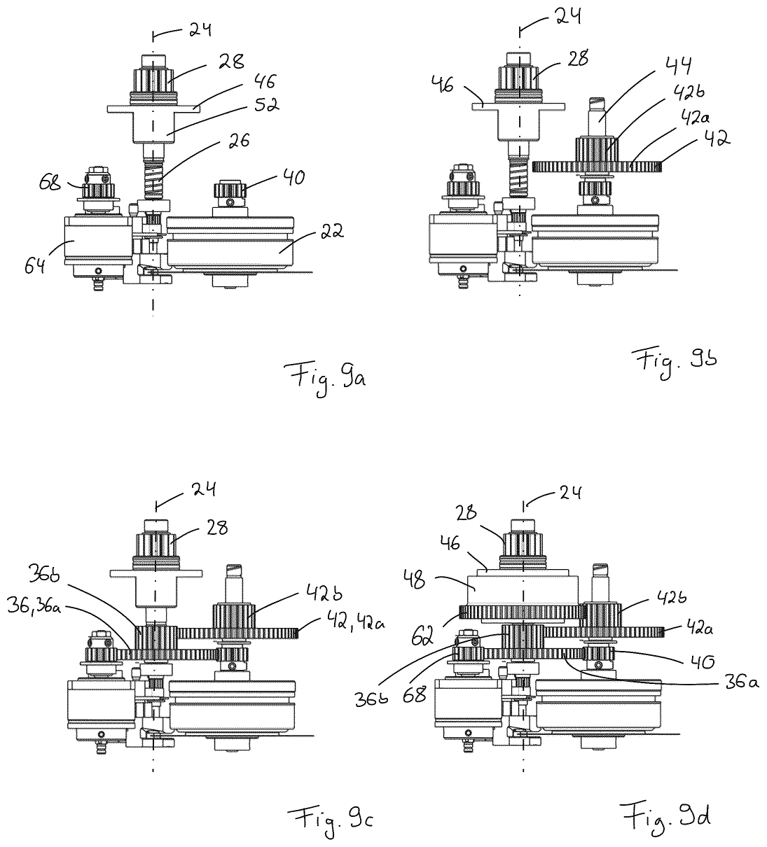

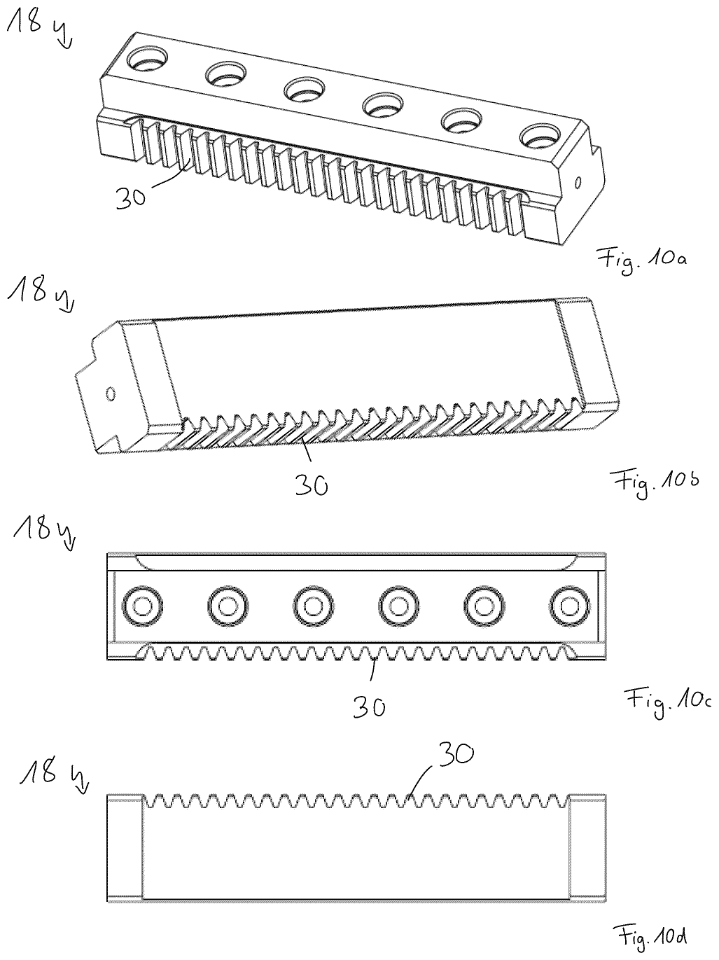

FIG. 9a shows a schematic side view of the transmission device according to the invention in a first assembly step;

FIG. 9b shows a schematic side view of the transmission device according to FIG. 9a in a second assembly step;

FIG. 9c shows a schematic side view of the transmission device according to FIG. 9a in a third assembly step;

FIG. 9d shows a schematic side view of the transmission device according to FIG. 9a in a fourth assembly step;

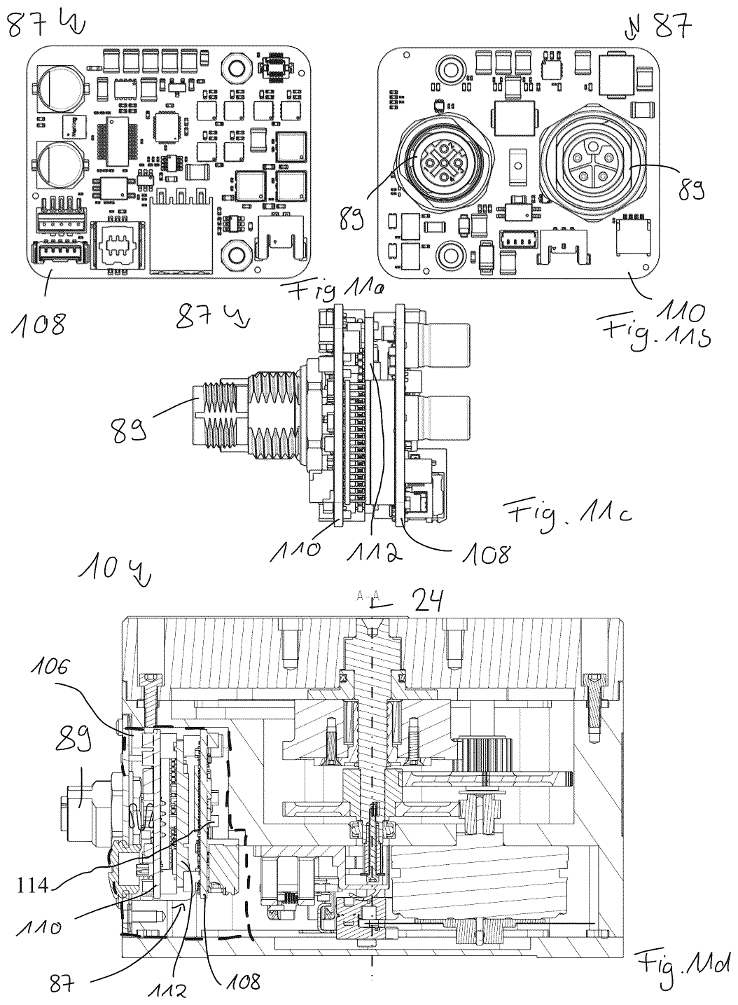

FIG. 10a shows a perspective top view of a gripping jaw according to the invention;

FIG. 10b shows a perspective bottom view of the gripping jaw according to FIG. 10a;

FIG. 10c shows a schematic top view of the gripping jaw according to FIG. 10a;

FIG. 10d shows a schematic bottom view of the gripping jaw according to FIG. 10a;

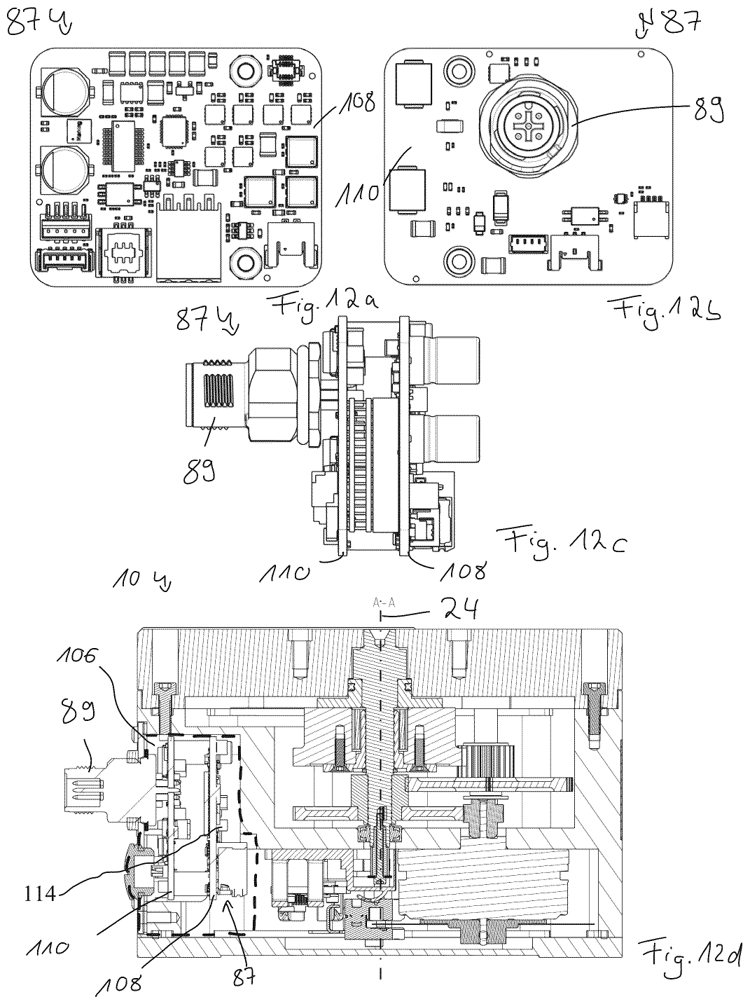

FIG. 11a shows a schematic top view of a control and regulation device according to the invention with Ethernet;

FIG. 11b shows a schematic bottom view of the control and regulation device according to FIG. 11a;

FIG. 11c shows a schematic side view of the control and regulation device according to FIG. 11a;

FIG. 11d shows a schematic sectional view of a clamping or gripping device according to the invention with a control and regulation device according to FIG. 11a;

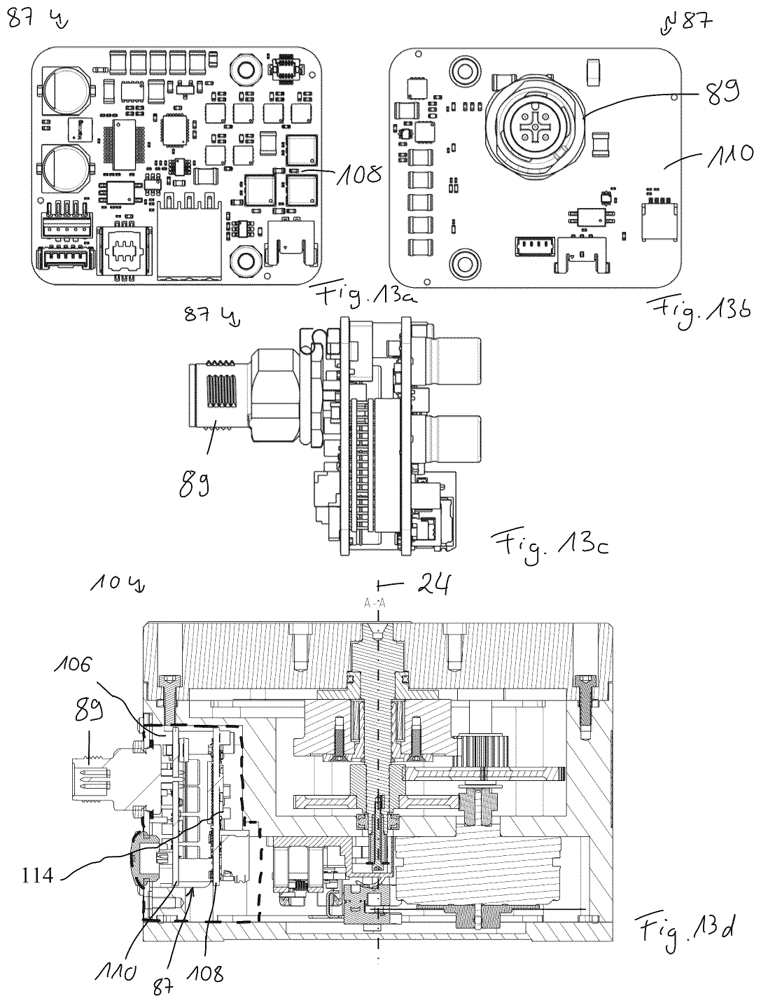

FIG. 12a shows a schematic top view of a control and regulation device according to the invention with IO-Link;

FIG. 12b shows a schematic bottom view of the control and regulation device according to FIG. 12a;

FIG. 12c shows a schematic side view of the control and regulation device according to FIG. 12a;

FIG. 12d shows a schematic sectional view of a clamping or gripping device according to the invention with a control and regulation device according to FIG. 12a;

FIG. 13a shows a schematic top view of a control and regulation device according to the invention with Modbus;

FIG. 13b shows a schematic bottom view of the control and regulation device according to FIG. 13a;

FIG. 13c shows a schematic side view of the control and regulation device according to FIG. 13a; and

FIG. 13d shows a schematic sectional view of a clamping or gripping device according to the invention with a control and regulation device according to FIG. 13a.

FIGS. 1 to 5 show an electrically actuatable clamping or gripping device 10 which is designed as a parallel gripper for clamping or gripping workpieces (not shown) with a main housing 12 and with a jaw guide 16 arranged in the main housing 12 and extending parallel to a guide axis 14. According to FIG. 1, the jaw guide 16 comprises a first jaw guide element 16a, a second jaw guide element 16b and a third jaw guide element 16c arranged between the first jaw guide element 16a and the second jaw guide element 16b. In the jaw guide 16, two gripping jaws 18 are provided which can be moved parallel to the guide axis 14 between a gripping position and a release position. The first gripping jaw 18a can be arranged between the first jaw guide element 16a and the third jaw guide element 16c and can be moved along a first guide axis 14a. The second gripping jaw 18b can be arranged between the second jaw guide element 16b and the third jaw guide element 16c and can be moved along a second guide axis 14b. The guide axes 14a and 14b run parallel and/or spaced from each other. The gripping jaws 18 can in particular have a stroke. The jaw guide 16 has a length L running parallel to the guide axis 14. When gripping or clamping internally, the release position can be provided such that both gripping jaws 18 have the greatest axial distance from each other, and the gripping position can be provided such that both gripping jaws 18 have the smallest axial distance from each other. A reverse orientation is also conceivable when gripping or clamping from the outside.

According to FIGS. 2 to 5, the gripping jaws 18 can be driven parallel to the guide axis 14 by means of a drive device 20 arranged in the main housing 12. The drive device 20 has a rotary drive 22, a drive shaft 26 which cooperates with the rotary drive 22 and extends along a drive axis 24, and a drive pinion 28 arranged on the drive shaft 26 for conjoint rotation. The drive axis 24 runs perpendicular to the guide axis 14. The drive shaft 26 is rotatably mounted in the main housing 12. The rotary drive 22 is designed as an electric external rotor motor. The drive power of the rotary drive 22 is transmitted to the drive pinion 28 by means of the drive shaft 26. The drive pinion 28 synchronizes the movement of both gripping jaws 18.

According to FIGS. 10a to 10d, a rack profile 30 with a toothing facing the third jaw guide element 16c is provided on the gripping jaws 18, wherein the drive pinion 28 has a toothing corresponding to the rack profile 30. The drive pinion 28 is arranged in the third jaw guide element 16c and in particular perpendicular to the guide axis 14 between the two gripping jaws 18. During operation, the toothing of the drive pinion 28 meshes with the toothing of the gripping jaw 18, in particular the rack profile 30. According to FIG. 3, the jaw guide 16 is preferably designed as a T-groove, and/or the gripping jaw 18 is designed as a T-profile.

The drive device 20 according to FIGS. 2 to 5 and FIGS. 7a to 9d further comprises a transmission device 32 and a clutch device 34. The transmission device 32 has a first double pinion 36 with a first pinion 36a and a second pinion 36b designed with a smaller diameter than the first pinion 36a. The first pinion 36a and the second pinion 36b are designed for conjoint rotation with one another, and in particular are designed in one piece or pressed together. The first double pinion 36 is driven by an output pinion 40 arranged on the motor shaft 38, wherein the output pinion 40 meshes with the first pinion 36a of the first double pinion 36 during operation. The transmission ratio between the output pinion 40 and the first pinion 36a of the first double pinion 36 lies in a range between 2 and 10, in particular in a range between 2 and 6, and preferably in a range between 2.9 and 5. The first double pinion 36 is rotatably mounted on the drive shaft 26. Accordingly, the first double pinion 36 can have a different rotational speed than the drive shaft 26.

According to FIGS. 2 to 5 and FIGS. 7a to 9d, the transmission device 32 also has a second double pinion 42 identical to the first double pinion 36. The second double pinion 42 also comprises a first pinion 42a and a second pinion 42b designed with a smaller diameter than the first pinion 42a. The first pinion 42a and the second pinion 42b are designed for conjoint rotation with one another, and in particular are designed in one piece or pressed together. The second double pinion 42 is arranged on a non-rotatable, in particular fixed, bearing shaft 44 arranged on the main housing 12. The bearing shaft 44 preferably extends parallel to the drive axis 24 and is arranged at a distance from the drive shaft 26 and/or the motor shaft 38. During operation, the first pinion 42a of the second double pinion 42 meshes with the second pinion 36b of the first double pinion 36. The transmission ratio between the second pinion 36b of the first double pinion 36 and the first pinion 42a of the second double pinion 42 lies in a range between 2and 10, in particular in a range between 2 and 6, and preferably in a range between 2.9 and 4.4.

The clutch device 34 according to FIGS. 7b to 8b is designed as a claw clutch and has a first clutch element 46, a second clutch element 48 and at least one elastomer element 50 arranged in the circumferential direction between the first clutch element 46 and the second clutch element 48. The first clutch element 46 is connected to the drive shaft 26 for conjoint rotation and has two claws 52 running parallel to the drive axis 24. The second clutch element 48 is rotatably mounted on the drive shaft 26 and has a clutch receptacle 54 for receiving the first clutch element 46, in particular the claws 52, and for receiving the elastomer element 50. The first clutch element 46 is arranged along the drive axis on the jaw side, in particular facing the drive pinion 28, and the second clutch element 48 is arranged on the motor side, in particular facing the rotary drive 22. The second clutch element 48 is designed in two parts according to FIG. 7d and has, in addition to the clutch receptacle 54, a clutch sleeve 56 pushed onto the drive shaft 26 with a clutch stop 58, wherein the clutch receptacle 54 is pushed onto the clutch sleeve 56. In FIG. 8a, the design of the claws 52 can be seen, wherein the claws 52 are designed trapezoidal and have rounded claw stop surfaces 52a for interaction with the elastomer element 50. The clutch receptacle 54 is designed to correspond to the claws 52, wherein a gap is provided for the elastomer element 50. The elastomer element 50 is in particular provided for securing the gripping force.

According to FIG. 7c, the clutch receptacle 54 has on its radially outer circumferential surface 60 a clutch pinion 62, wherein the clutch pinion 62 meshes with the second pinion 42b of the second double pinion 42 during operation. The transmission ratio between the second pinion 42b of the second double pinion 42 and the clutch pinion 62 is in a range between 2 and 10, in particular in a range between 2 and 6, and preferably in a range between 2.9 and 3.8.

Consequently, the power of the rotary drive 22 is transmitted to the gripping jaws 18 by means of the output pinion 40, the first double pinion 36, the second double pinion 42, the clutch device 34, and the drive pinion 28. In particular, the first double pinion 36, the clutch device 34 and the drive pinion 28 are arranged on the drive shaft 26.

According to FIG. 5, a braking device 64 engages with the first double pinion 36, in particular with the first pinion 36a of the double pinion 36, and has a magnetic brake 66 with a brake pinion 68 arranged on a brake shaft 67. In the event of a loss of energy by the drive device 20, the gripping force of the gripping jaws 18 can be maintained by means of the braking device 64.

Furthermore, the drive shaft 26 has a first free end 70 facing the rotary drive 22 and a second free end 72 facing the gripping jaws 18 and opposite the first free end 70 along the drive axis 24. The drive pinion 28 is arranged on the second free end 72 of the drive shaft 28. According to FIGS. 8a to 8c, a measuring portion 74 is provided on the first free end 70 of the drive shaft 26, wherein the measuring portion 74 can be formed integrally with the drive shaft 26 or can be fastened to the drive shaft 26 by means of a fastening means 76 extending along the drive axis 24, in particular a screw. The measuring portion 74 is designed in particular as a measuring pinion 78 that is fixed for conjoint rotation with the drive shaft 26.

The measuring portion 74 serves for connection to a position measuring device 80. The position measuring device 80 is designed and/or configured to detect the angle of rotation of the drive device 20, in particular of the rotary drive 22 and/or the drive shaft 26, and/or the position of at least one gripping jaw 18. For this purpose, according to FIGS. 8a and 8b, an angle measuring device 78 is provided which is connected to the drive shaft 26 by means of a belt 84. The belt 84 transmits the rotation from the drive shaft 26 to the angle measuring device 82, in particular to a sensor pinion 86 arranged on the angle measuring device 82. The belt 84 and/or the measuring pinion 78 and/or the sensor pinion 86 are designed such that the rotational speed of the drive shaft 26 is reduced toward the angle measuring device 82. The transmission ratio is configured such that the entire stroke of the gripping jaw 18 corresponds at most or exactly to one rotation of the angle measuring device 82, in particular of the sensor pinion 86. Accordingly, a simple and inexpensive single-turn encoder can be used as an angle measuring device 82.

The clamping or gripping device 10 further has, according to FIG. 2, a control and regulation device 87 in the main housing 12, wherein this device is designed and/or configured to control and/or regulate the drive device 20, the braking device 64, and the position measuring device 80. The clamping or gripping device 10 can be supplied with electrical energy via interfaces 89. Furthermore, additional media and/or information can be transmitted via the interfaces 89.

The main housing 12 has an outer housing 88 and a partition 90 according to FIG. 2 to FIG. 6a. The outer housing 88 comprises a housing cover 92 extending parallel to the guide axis 24, a housing casing 94 extending parallel to the drive axis, and a housing base 96 extending parallel to the guide axis 24. The partition 90 is arranged in the main housing 12 and extends between the inner sides of the housing casing 94. The partition 90 divides the interior of the main housing 12 into a transmission and/or clutch portion 98 and an electronic portion 100.

At least one or more of the following components, preferably all, are arranged in the transmission and/or clutch portion 98: clutch device 34, in particular first clutch element 46, second clutch element 48, elastomer element 50; transmission device 32, in particular first double pinion 36, second double pinion 42; bearing shaft 44; drive shaft 26; drive pinion 40; and brake pinion 68.

At least one or more of the following components, preferably all, are arranged in the electronic portion 100: rotary drive 22; drive shaft 26, in particular the first free end of the drive shaft 70, measuring portion 74, measuring pinion 78; position measuring device 80, in particular angle measuring device 82, belt 80; magnetic brake 66; and control and regulation device 87.

By separating the main housing 12 by means of the partition 90, the sensitive electrical components are protected from the harsh environment of the transmission and/or clutch device.

Furthermore, according to FIGS. 3, 6 and 6a, the partition 90 is designed in a step-like manner, wherein in particular in the region of the drive axis 24, the partition 90 is set back toward the electronic portion 100, and in the region of the control and regulation device 87, the partition 90 is set back toward the transmission and/or clutch portion 98. Accordingly, despite the separation, there is sufficient installation space for arranging the transmission device 32 and the clutch device 34 in the transmission and/or clutch portion 98 and the control and regulation device 87 in the electronic portion 100.

The main housing 12, in particular the partition 90 and the outer housing 88, is protected from the external environment by seals 102, in particular flat seals. Furthermore, it is advantageous that seals 102, in particular flat seals, are also provided in the interior of the main housing 12, i.e. between the transmission and/or clutch portion 98 and the electronic portion 100.

It turns out to be particularly advantageous that the drive shaft 26 extends from the gripping jaws 18 through the transmission and/or clutch portion 98 into the electronic portion 100. The drive shaft 26 extends through the partition 90. The drive shaft 26 is rotatably mounted in the partition 90 by means of a bearing element 101. In particular, the first free end 70 or the measuring portion 74 of the drive shaft 26 protrudes into the electronic portion 100. Accordingly, the rotational speed of the drive shaft 26, in particular of the drive pinion 28, and/or the position of the gripping jaw 18 can be detected particularly easily. However, to do this, it is not necessary for the position measuring device 80 to be arranged on the gripping jaw 18 or in the transmission and/or clutch portion 98. This allows for highly accurate and long-lasting measurement. Furthermore, the partition 90 has openings 91 for the drive shaft 26, the motor shaft 38, the bearing shaft 44 and/or the shaft of the braking device 64.

According to FIGS. 3 and 3a, the partition has a receptacle 106 for receiving the position measuring device 80, wherein the sensor pinion 86 is rotatably mounted in the partition 90 by means of a bearing element 101. The brake shaft 67 is rotatably mounted in the housing base 96 and in the partition 90 by means of two bearing elements 101.

FIGS. 9a to 9d show how the drive device 20 can be mounted in the main housing 12, wherein for the sake of clarity, only the drive device 20 is shown in different assembly stages. First, the housing casing 94 is screwed together with the partition 90. The rotary drive 22, the braking device 64 and the position measuring device can then be introduced on the bottom side. The housing base can then be screwed onto the housing casing 94. Furthermore, the drive shaft 26 and the bearing shaft 44 can be introduced on the cover side. Then, the output pinion is pushed onto the motor shaft 38 on the cover side, the first double pinion 36 is pushed onto the drive shaft 26, and then the second double pinion 42 is pushed onto the bearing shaft 44. Furthermore, the brake pinion 68 is mounted on a shaft of the braking device 64. The clutch device 34 is then assembled by first pushing the second clutch element 48 with the elastomer element 50 onto the drive shaft 26. Subsequently, the first clutch element 46 and the drive pinion 28 are mounted on the drive shaft 26. Finally, the housing cover 92 can be screwed onto the outer housing 88. The multifunctionality of the drive shaft 26 shows that the clamping or gripping device 10 is particularly easy to assemble.

Furthermore, according to FIGS. 2 to 4, in the electronic portion 100, in particular on the position measuring device 80, the braking device 64 and/or the control and regulation device 87, cable holders 104 are provided for holding and guiding the cables (not shown) connecting the components.

In FIGS. 11a to 11d, a control and regulation device 87 with Ethernet communication is shown. According to FIG. 11d, the control and regulation device 87 is arranged in a circuit board space 106 which is delimited by the partition 90, in particular the step of the partition 90, the housing casing 94 and the housing base 96 and which is shown by the dashed line. The control and regulation device 87 has a motherboard 108, a communication circuit board 110 and an Ethernet communication circuit board 112. The circuit boards 108, 110, 112 are arranged parallel to the drive axis 24.

In FIGS. 12a to 12d, a control and regulation device 87 with IO-Link communication is shown. The control and regulation device 87 is arranged in the circuit board space 106 as shown in FIG. 12d. The control and regulation device 87 has a motherboard 108 and a communication circuit board 110. The circuit boards 108, 110 are arranged parallel to the drive axis 24.

In FIGS. 13a to 13d, a control and regulation device 87 with Modbus communication is shown. The control and regulation device 87 is arranged in the circuit board space 106 according to FIG. 13d. The control and regulation device 87 has a motherboard 108 and a communication circuit board 110. The circuit boards 108, 110 are arranged parallel to the drive axis 24.

The motherboard 108 is designed the same regardless of the changing communication circuit board 110 and automatically recognizes which of the communication circuit boards 110 is being used. A brake chopper 114 is arranged on the motherboard 108 to reduce the feedback voltage of the rotary drive 22 in order to protect a power supply connected to the clamping or gripping device 10.

It is particularly advantageous that a clamping or gripping device 10 is designed with a brake chopper 114 arranged in the main housing 12. The brake chopper 114 integrated in the clamping or gripping device 10 enables a measurement of the feedback voltage in the braking device 64 close to the brake and thereby a targeted reduction of the feedback voltage during a braking operation of the braking device 64.

### LIST OF REFERENCE NUMBERS

L Length of the jaw guide
10 Clamping or gripping device
12 Main housing
14, 14a, 14b Guide axis
16 Jaw guide
16a, 16b, 16c Jaw guide element
18, 18a, 18b Gripping jaw
20 Drive device
22 Rotary drive
24 Drive axis
26 Drive shaft
28 Drive pinion
30 Rack profile
32 Transmission device
34 Clutch device
36 First double pinion
36a, 36b Pinion of the first double pinion
38 Motor shaft
40 Output pinion
42 Second double pinion
42a, 42b Pinion of the second double pinion
44 Bearing shaft
46 First clutch element
48 Second clutch element
50 Elastomer element
52 Claws
52a Claw stop surface
54 Clutch receptacle
56 Clutch sleeve
58 Clutch stop
60 Circumferential surface of the clutch receptacle
62 Clutch pinion
64 Braking device
66 Magnetic brake
67 Brake shaft
68 Brake pinion
70 First free end of the drive shaft
72 Second free end of the drive shaft
74 Measuring portion
76 Fastening means for measuring portion
78 Measuring pinion
80 Position measuring device
82 Angle measuring device
84 Belt
86 Sensor pinion
87 Control and regulation device
88 Outer housing
89 Interfaces
90 Partition
91 Openings in partition
92 Housing cover
94 Housing casing
96 Housing base
98 Transmission and/or clutch portion
100 Electronic portion
101 Bearing element
102 Flat seals
104 Cable holder
106 Circuit board space
108 Motherboard
110 Communication circuit board
112 Ethernet communication circuit board
114 Brake chopper

1.-16. (canceled)

17. A clamping or gripping device (10), in particular parallel gripper, comprising:
a main housing (12), with at least one jaw guide (16) arranged in the main housing (12) and extending along a guide axis (14, 14a, 14b), with at least one gripping jaw (18, 18a, 18b) which is movable in the jaw guide (16) between a gripping position and a release position, with a drive device (20) for moving the at least one gripper jaw (18, 18a, 18b), wherein the drive device (20) has a rotary drive (22) and a drive shaft (26) extending perpendicular to the guide axis (14, 14a, 14b) and rotatably mounted in the main housing (12) for connecting the rotary drive (22) and the at least one gripping jaw (18, 18a, 18b) and a transmission device (32) and/or a clutch device (34), with a position measuring device (80) for detecting the angle of rotation of the drive device (20), in particular the rotary drive (22) and/or the drive shaft (26), and/or for detecting the position of the at least one gripping jaw (18, 18a, 18b), wherein the main housing (12) has a partition wall (90) which divides the interior of the main housing (12) into a transmission and/or clutch portion (98) in which the transmission device (32) and/or the clutch device (34) is arranged, and into an electronics portion (100) in which the rotary drive (22) and/or the position measuring device (80) is arranged, wherein the drive shaft (26) extends into the electronics portion (100), the transmission and/or clutch portion (98) is arranged between the at least one gripping jaw (18, 18a, 18b) and the electronics portion (100), wherein the drive shaft (26) has a first free end (70), and wherein the first free end (70) of the drive shaft (26) is arranged in the electronics portion (100), wherein a drive pinion (28) formed separately from the transmission device (32) and/or the clutch device (34) is arranged at a second free end (72) of the drive shaft (26), wherein a rack profile (30) is arranged on the at least one gripping jaw (18, 18a, 18b), which is formed separately from the transmission device (32) and/or the clutch device (34) and interacts with the drive pinion (28).

18. The clamping or gripping device (10) according to claim 17, wherein the drive shaft (26) extends through the transmission and/or clutch portion (98).

19. The clamping or gripping device (10) according to claim 17, wherein the drive shaft (26) is rotatably mounted in the partition wall (90).

20. The clamping or gripping device (10) according to claim 17, wherein the position measuring device (80) includes an angle measuring device (82) cooperating with the drive shaft (26) and/or includes a belt (84).

21. The clamping or gripping device (10) according to claim 20, wherein the angle measuring device (82) is connected to the drive shaft (26) by means of the belt (84), wherein the belt (84) reduces the rotational speed of the drive shaft (26) towards the angle measuring device (82).

22. The clamping or gripping device (10) according to claim 17, wherein the rotary drive (22) has a motor control device, including an incremental encoder for motor control and commutation.

23. The clamping or gripping device (10) according to claim 17, wherein the clamping or gripping device (10) includes the clutch device (34), wherein the clutch device (34) acts as a claw coupling including a first clutch element (46), a second clutch element (48) and at least one elastomer element (50) arranged in the circumferential direction between the first clutch element (46) and the second clutch element (48).

24. The clamping or gripping device (10) according to claim 23, wherein the first clutch element (46) faces the drive pinion (28) and is connected to the drive shaft (26) for conjoint rotation, and wherein the second clutch element (48) faces away from the drive pinion (28) and is rotatably mounted on the drive shaft (26).

25. The clamping or gripping device (10) according to claim 17, wherein the clamping or gripping device (10) includes the transmission device (32), wherein the transmission device (32) includes a first double pinion (36) arranged on the drive shaft (26), wherein a bearing shaft (44) extending parallel to and at a distance from the drive shaft (26) is provided in the main housing (12), in particular the transmission and clutch portion (98), and wherein a second double pinion (42) cooperating with the first double pinion (36) is arranged on the bearing shaft (44).

26. The clamping or gripping device (10) according to claim 25, wherein the second clutch element (48) has a clutch pinion (62) which cooperates with the second double pinion (42).

27. The clamping or gripping device (10) according to claim 25, wherein the rotary drive (22) is designed as an external rotor motor and has an output pinion (40) cooperating with the first double pinion (36).

28. The clamping or gripping device (10) according to claim 17, wherein a braking device (64) is provided on the drive device (20) to maintain the gripping force.

29. The clamping or gripping device (10) according to claim 28, wherein the clamping or gripping device (10) includes a control and control device (87) for controlling and/or regulating the drive device (20), the braking device (64), the position measuring device (80) and/or the control device.
